(19) United States
(12) Patent Application Publication
(10) Pub. No.: US 2014/0149038 A1
(43) Pub. Date: May 29, 2014

(54) SOLAR IRRADIANCE MEASUREMENT SYSTEM AND WEATHER MODEL INCORPORATING RESULTS OF SUCH MEASUREMENT

(71) Applicant: The Arizona Board of Regents on Behalf of The University of Arizona, Tucson, AZ (US)

(72) Inventors: Alexander D. Cronin, Tucson, AZ (US); Vincent Lonji, Tucson, AZ (US); William Holmgren, Tucson, AZ (US); Antonio Lorenzo, Tucson, AZ (US); Eric Betterton, Tucson, AZ (US); Michael S. Leuthold, Tucson, AZ (US)

(21) Appl. No.: 14/090,602

(22) Filed: Nov. 26, 2013

Related U.S. Application Data
(60) Provisional application No. 61/797,043, filed on Nov. 28, 2012.
(60) Provisional application No. 61/797,346, filed on Dec. 5, 2012.
(60) Provisional application No. 61/820,797, filed on May 8, 2013.
(60) Provisional application No. 61/857,144, filed on Jul. 22, 2013.

(51) Int. Cl. G01W 1/10

(52) U.S. Cl. CPC G01W 1/10
USPC 702/3

(57) ABSTRACT

A measurement system and method of forecasting time-dependent corrections into a power output of photovoltaic power generators based on a determination of time-dependent shading of photovoltaic cells. Identification of cloud positioning in the sky is based on recordation of images of a scene within a field-of-view FOV that optionally subtends the Sun, base on which images a velocity vector associated with cloud movement is computed to form output associated with time when clouds will shade power generators in question. A method for producing a weather forecast based on such corrections.

### CROSS-REFERENCE TO RELATED APPLICATIONS

The present application claims priority from and benefit of the commonly assigned U.S. Provisional Patent Applications Nos. 61/797,043 (docket no. UA13-054), filed on Nov. 28, 2012 and titled “Adapting WRF for Operational Solar Irradiance Forecasting in the Southwestern United States: Clouds and Aerosols”, 61/797,346 (docket no. UA13-063), filed on Dec. 5, 2012 and titled “Forecasting Variable Output from Photovoltaic Generating Facilities Due to Clouds”; 61/820,797 (docket no. 122170.00050), filed on May 8, 2013 and titled “Solar irradiance measurement system and weather model incorporating results of such measurement”; and 61/857,144 (docket number 122170.00054), filed on Jul. 22, 2013 and titled “Solar Irradiance Measurement System and Weather Model Incorporation Results of Such Measurement”. The disclosure of each of the above-mentioned provisional applications, including all material included in their respective appendices, is incorporated herein by reference in its entirety.

### STATEMENT REGARDING FEDERALLY SPONSORED RESEARCH OR DEVELOPMENT

This invention was made with government support under Grant Number DE-OE0000181 awarded by the Department of Energy. The U.S. government has certain rights in the invention.

### TECHNICAL FIELD

The present invention relates to irradiance detector systems and weather models and, in particular, to a system including a spatial network of irradiance detectors and structured (i) to determine an estimate of solar irradiance maps based on atmospheric conditions and (ii) to produce an output facilitating a prediction—for the electrical power generated from solar power plants and/or wind power plants for a time period in the future. In addition, this invention relates to improving weather mode algorithms utilizing such output. The invention is further directed to direct and indirect irradiance sensors for measuring solar irradiance.

### BACKGROUND

An often criticized feature of renewable, variable power-generation sources (VPGs) is their unpredictability. In contrast to VPGs such as wind and solar, traditional, non-renewable energy sources are capable of supplying whatever power is needed, in a constant and predictable fashion, to meet varying demands. As the percentage of power from VPG sources continues to increase, utility companies have an increasing need for accurate and detailed power forecasts from these resources. The uses of such power forecasts are many and include, for example, power production forecasting, scheduling practices, marketing, grid balancing, and dispatch and curtailment. Significant cost savings can be realized by having access to accurate forecasts of VPG resources. Benefits include less reserves carried, increased stability of the power grid, marketing advantages, reduction of the use of conventional generation fuels, reduction in CO₂ outputs, and lower occurrence of penalties, to name just a few.

Currently weather modeling is relied on to estimate solar irradiance for solar VPG generations. However, Numerical Weather Prediction (NWP), which is the primary forecast tool for meteorologists, cannot be routinely relied on in the Southwest and regions having similar climate and landscape. Indeed, the unique weather conditions found in Southwestern portion of the USA, particularly in Arizona, present significant challenges for accurate weather forecasting, and therefore, for accurate time-varying solar irradiance forecasting. The mountainous terrain combined with the extremes in moisture and heat can produce very significant weather events that impact localized areas in ways that are not predicted by NWP. That are difficult to predict even with high resolution (less than 2 km horizontal) NWP. Cloud cover, localized flash flooding, damaging winds and dust storms are just some examples. The application of NWP to local solar irradiance prediction is even more problematic because it cannot account for changes in local conditions brought about by rapid changes in land surface use, changing humidity due to specifics of irrigation conditions, and distributions of winds that carry the clouds that block the sunlight, to name just a few. In fact, not only do many NWP models fail to be an accurate enough predictive tool for variations in solar irradiance, many also fail to attain the ultimately desired accuracy when predicting other weather events such as freezing temperatures for agriculture, and wind for renewable energy.

The National Center for Atmospheric Research (NCAR) states on its web page, for example: “As wind and solar energy portfolios expand, this forecast problem is taking on new urgency because wind and solar energy forecast inaccuracies frequently lead to substantial economic losses and constrain the national expansion of renewable energy. Improved weather prediction and precise spatial analysis of small-scale weather events are crucial for energy management, as is the need to further develop and implement advanced technologies.” (Web-article title “NCAR's Contribution to Wind and Solar Energy Prediction” available at http:/ral.ucar.edu/projects/windSol/)

The National Renewable Energy Laboratory (NREL) has published several studies related to this topic. One NREL study titled “Impact of High Solar Penetration in Western Interconnection” states: “In addition to being variable, the production of solar cannot be perfectly predicted. Forecasting solar production is receiving a considerable amount of attention in the industry. The state of the art has not progressed as far as that for wind generation.” “Forecasting of solar generation for high penetration systems will be required for economic operation. The forecast used in the study is relatively crude, and could be expected to improve with technology. The combination of variability and uncertainty impacts the operation of the grid.” (available at http://www.nrel.gov/docs/fy11osti/49667.pdf)

Another NREL report titled “How Do High Levels of Wind and Solar Impact the Grid? The Western Wind and Solar Integration Study (available at (http://www.nrel.gov/docs/fy11osti/50057.pdf) states: “Integrating day-ahead wind and solar forecasts into the unit commitment process is essential to help mitigate the uncertainty of wind and solar generation. Even though SOA [state of the art] wind and solar forecasts are imperfect and sometimes result in reserve shortfalls due to missed forecasts, it is still beneficial to incorporate them into the day-ahead scheduling process because this will reduce the amount of shortfalls. Over the course of the year, use of these forecasts reduces WECC operating costs by up to 14%, or $5 billion/yr ($4 billion/yr in 2009$), which is $12-20/MWh ($10-17/MWh in 2009$) of wind and solar generation. The incremental cost savings for perfect wind and solar day-ahead forecasts would reduce WECC operating costs by another $500 million/yr ($425 million/yr in 2009$) in the 30% case, or $1-2/MWh ($0.90-1.70/MWh in 2009$) of wind and solar generation.”

As is suggested by the NCAR and NREL reports, imprecise weather prediction impacts the operation of the energy-providing companies in a rather drastic fashion, on both the demand and supply sides. For example, our empirical data show that the output of large PV power plants can be reduced very rapidly by moving cloud shadows.

More specifically, empirical data were obtained showing that the output from a 1.6 MW PV plant has occasionally been as rapidly as 800 kW in just 10 seconds because of clouds. That is 50% of the PV power plant's rated output in just 10 seconds. Even 100 MW PV power plants are not immune to similar effects. Accordingly, if the prediction is incorrect and the power company does not have an energy-back-up means prepared for the occasion, the economy of the region may be significantly affected. Clouds are the majority contributor to inaccurate forecasts mainly due to their poor representation in initial conditions of currently accepted models. Deficiencies in model physics and insufficient model resolution also contribute to inaccurate forecasts. According to various estimates, the precise wind power forecasts can save anywhere from 2 to 5 dollars per MW hour.

Even in Arizona, which is thought of as an ideal region for solar power generation, fluctuations in solar power due to clouds is a serious problem for utility companies. Electric utility companies have two conflicting goals, both of which are mandated by regulations. First, they are expected to provide reliable, uninterrupted, power. Second, they are required to get more energy from renewable resources. These goals are in conflict because renewable resources such as solar power are variable and intermittent. This problem is becoming urgent. In 2012 the Arizona Corporation Commission mandated, for example, that utility companies get 4% of their energy from renewable resources. For Tucson Electric Power Company, for example, this is mostly provided by solar photovoltaic (PV) systems. This means that at noontime on a sunny day in May 2013, for example, more than 25% of TEP's power is required to come from solar energy. This is alarming because unexpected dropouts in solar power due to clouds could lead to grid failure.

FIG. 1 illustrates the inherent unreliability of power output forecasts based on a commonly-used WRF (Weather Research and Forecasting) numerical atmospheric model. FIG. 1 is a comparison of the plot representing a WRF prediction of a photovoltaic output (which is nearly proportional to irradiance at the PV installation site) with the actual photovoltaic output over a 5 day period for a particular PV installation located in Arizona. As can be seen in FIG. 1, the WRF model can be quite erroneous in the timing of clouds, which can drastically reduce PV output, as in day 4 (corresponding to a portion of FIG. 1 labeled 4/9/11). Additionally, weather models are deficient in that they can predict the absence of clouds when clouds are, in fact, present, as in days 1 and 2 (labeled in FIG. 1 as 4/6/11 and 4/7/11). This is because while the WRF model is able to predict large-scale cirrus clouds as well as days that are entirely cloudy, it is not equipped for prediction of smaller-scale (optionally moving) clouds on partially cloudy days. Clearly, alternative methods enabling precision forecasting of changes in solar-to-electrical power conversion (at the utility plant) due to variable cloud cover are required.

Utility companies in general are cautious to adopt solar energy at the industrial scale because of the grid instability associated with unpredictable fluctuations in irradiance due to cloud cover. Fast moving clouds can cause solar electric power loss or gain of 20% to 30% per second, as shown in FIG. 2, for example, in comparison with the clear-sky expectation. FIG. 2 illustrates a histogram of ramp rates, where the x-axis represents the amount of time it takes to reach a zero level from the level of the peak power for a measure ramp rate. As can be seen in FIG. 2, the ramp rate necessary to compensate for rapid changes in cloud cover is drastically greater than the ramp rate needed to compensate for the relatively slow change in solar irradiance during the course of a day.

Utility companies, or PV power plant operators, or other parties may curtail the output of PV power plants in order to reduce the ramp rate of the system. This can make some PV systems comply with mandated maximum ramp rates in some regions. However, without accurate forecasts, such curtailment strategy is not well enough informed and will result in unnecessary reduction of energy output, and hence loss of potential benefits. With reliable forecasts, curtailment strategies can be optimized.

Utility companies, solar power plant operators, or other parties may operate energy storage devices in conjunction with solar power plants in order to produce desired ramp rates for the otherwise variable PV power. This approach will also benefit from reliable forecasts of PV power. Without forecasts, such a battery control strategy will be poorly informed and will therefore have several shortcomings, including non-optimal states of charge and unnecessary grid-synchronization costs. With reliable forecasts, the battery state of charge can be allowed to rise higher or drop lower than would otherwise be advisable. With reliable forecasts, the energy and financial costs associated with keeping a battery control system synchronized to the 60 Hz electric grid, can be avoided until it is certain that the battery will be needed. Since synchronizing the battery control system to the grid frequency can take some time, up to several minutes, a reliable forecast is desirable to provide an early warning for the battery control system.

Until solar power intermittency becomes predictable and dispatchable, utility companies may continue to overproduce electricity as a backup for the solar power plants. Utility companies are required to maintain an amount of fast acting spinning reserves to handle unexpected events such as power plant failures or solar power plant fluctuations. With reliable and accurate forecasts, the electric utilities should be able to reduce the amount of spinning reserves needed to provide backup for the solar power plants.

To the extent that forecasts are accurate and reliable, utility companies may be able to count distributed PV power, power that is generated on residential and small business rooftops behind the meter, as reliable negative load. Without accurate forecasts, utility companies may be obliged to carry additional spinning reserves to provide backup for distributed solar power generation too.

What is needed is a system and method enabling more accurately forecast of atmospheric conditions locally, in the vicinity of VPG facilities. The methods that we have invented to develop and optimize such a system can be applied in many regions of the world. Some aspects of our system have been developed to perform especially well in the Southwest region of the USA.

### SUMMARY OF THE INVENTION

In accordance with embodiments of the present invention, a method and system are disclosed for forecasting of PV power output. Such system and method enable (i) the identification of the causes of the system's performance variations (such as shading, spatial orientation of the system, outages, and weather conditions) and (ii) improvement of forecast of a numerical weather model that utilizes cloud shadow opacity, position, and velocity measurements carried out with a system of the invention. Generally, a method for forecasting power output from PV systems under the cloudy skies utilizes time-dependent irradiance data acquired from ground-based irradiance sensors as an input to form a map of irradiance in real time. With the use of wind data that is obtained, for example, from the time-dependent irradiance map itself or from a pre-existing numerical weather model and the use of a clear-sky irradiance profile (as reference data), predictions of the future irradiance time series and predictions of future PV power time series are made. Also, this invention includes methods to recommend optimal locations for irradiance sensors to improve or implement future embodiments of forecasting systems. In particular, in one embodiment, the invention is directed to using direct or indirect irradiance measurements on the ground in the greater vicinity of VPG installations (such as PV fields) to either predict changes in solar irradiance directly, or to augment existing solar irradiance predictions generated by weather prediction models. Descriptions of particular irradiance measurement instruments and arrangements of instruments are to carry out ground irradiance measurements are provided.

In other embodiments, the invention includes a system for imaging the sky in the greater vicinity of VPG installations to detect and predict the movement of clouds, which may shade the VPG installation. In particular, the measurements of solar irradiance can be effectuated by employing a so-called “all-sky” camera means (for example, cameras positioned, effectively, on or in association with the ground and directed to look up in the sky) and/or satellite means (for example, cameras disposed on satellites around the Earth that are pointed down towards the Earth's surface). When combined with weather data including wind direction data, such imagery can used to predict shading in the vicinity of PV installations.

In one embodiment, a method for forecasting power variations from a photovoltaic (PV) system due to transient weather phenomena is provided. Such method includes (i) acquiring time-dependent data from the spatial network of irradiance sensors; and (ii) determining a clear sky expectation function including effects of shading on the irradiance sensors to form a determined clear sky expectation function with a data-processing system including a central server in communication with a spatial network of irradiance sensors. The method further includes (iii) correcting the determined clear sky expectation function for at least one of a presence of clouds, power outage, communications outage, partial shade, and orientation of an irradiance sensor to derive derated clear sky expectation function; and (iv) determining a position-dependent clearness index representing power output from irradiance sensors. The method additionally includes (v) estimating said clearness index at a second time based at least on a component of a velocity of clouds at a first time, the second time being greater than the first time.

In a related embodiment, a method for producing a weather forecast with a use of an optical detector unit is provided, that includes the step of determining a figure-of-merit (FOM) representing a time-dependence of a change in a power output from the optical detector unit based on at least first data representing irradiance of sunlight received by the optical detector unit, second data representing shading of the optical detector unit, third data containing information about a wind velocity, and fourth data describing orientation of the optical detector unit. Such determining is optionally carried out with a data processing unit. The method further includes a step of executing a weather research and forecasting (WRF) model that includes the FOM as an initial condition to obtain a weather model output corrected for presence of clouds.

In an alternative embodiment a method for predicting cloud shading is provided, which includes recording images of a scene within a field-of-view (FOV) of an imaging system positioned near ground to produce a time-sequential set of image frames, such that the FOV subtends the Sun; and identifying a cloud in an image frame of interest to determine a first position thereof in the image frame. The method additionally includes comparing the first position with a second position of the same cloud in a previous image frame; and computing a velocity vector on a basis of a difference between the first and second positions.

Embodiments of the invention confer certain advantages over conventional methods of forecasting solar irradiance based solely on numerical weather models. For example, the availability of time-specific prediction of shading of the PV-based power source(s) enables and/or facilitates the scheduling of the synchronization of the back-up generators with the electrical power grid when required and keeping the back-up generators uncoupled from the grid when no cloud cover is predicted. According to some estimates, having fully dispatchable solar power will result in a PV energy cost of 38% compared to the current intermittent power source. Intermittency can be mitigated with a combination of energy storage, spinning reserves, and demand response. Embodiments of the invention enable all of these techniques by providing the ability to forecast the intermittent solar resource in each geographical location utilizing solar power.

Embodiments of the invention also improve the efficient management of spinning reserves as well as new smart-grid technologies. These systems rely on advanced knowledge of the magnitude and duration of a cloud event even before it occurs, as well as the timing and the ramp rate of a cloud-induced intermittency. Embodiments of the invention enable forecasts having multiple forecast-horizons, which are valuable for utility operators and plant owners. A “day-ahead” forecast is useful, for example, for optimal energy trading strategy in the energy market, while an “hour-ahead” forecast is necessary for grid operators to manage and schedule spinning reserves.

Based on the empirical characterization of the PV power intermittency over a course of one year, it was shown that most of the cloud events occur at short (about 10 minutes) time scale. In numerical weather prediction models, capable of forecasting clouds several days ahead but with low accuracy (of only several hours) of arrival, as well as the coarse spatial-resolution analysis of cloud motion based on satellite imagery are insufficient to forecast intermittencies at such short time-scale. Therefore, ground-based cloud imaging methods can potentially improved the efficiency of operation of solar-aware smart grids.

These and other features, aspects, and advantages of the present invention will become better understood upon consideration of the following detailed description and drawings.

### BRIEF DESCRIPTION OF THE DRAWINGS

The invention will be more fully understood by referring to the following Detailed Description in conjunction with generally not-to-scale Drawings, of which:

FIG. 1 is comparison of a plot corresponding to the measured PV output with PV output predicted using conventional WRF modeling.

FIG. 2 is a histogram of ramp rates, i.e., the inverse of the derivative of the PV-generated time-series and representing the time it takes to go from the peak power to zero power of the derivative stays constant, for a particular PV installation.

FIG. 3 is a plot representing a ten-minute-ahead forecast of clouds in the sky according to an embodiment of the invention using an all-sky camera to track clouds, as compared to measured data.

FIG. 4 depicts a plot showing the results of solar irradiance measurements carried out by a network of optical (PV) detectors of the invention and forecasts of PV performance based on a clear sky model, a persistence model, and a 45-minute-ahead approach according to an embodiment of the invention.

FIG. 5 represents a functional dependence denoting location of the irradiance sensors of the array of the sensors according to an embodiment of the invention that has been optimized for solar irradiance measurements as a function of a forecast horizon for a cloud velocity of about 40 km/hr.

FIG. 6 shows plots of data comparing irradiance cause by sunlight and detected by a standard photodiode (facing a direction of about 4 degree latitude) and an embodiment of a scatterscope of the invention facing in a direction substantially parallel to the ground.

FIG. 7 illustrates an embodiment employing two irradiance sensors (indicated with red arrows) co-located on one instrument. Perspective view (left) and top view (right) are shown. In one example of operation, one sensor faces East, the other faces West, and both are oriented at approximately 45-degrees altitude, in order to have one facing towards the sun at all times of day.

FIG. 8 includes plots illustrating empirical irradiance data collected by the embodiment of FIG. 7.

FIG. 9 presents plots showing simulation of the irradiance signal reported by sensors facing east or west at 45 degrees altitude, and also for a horizontal sensor that monitors global horizontal irradiance (GHI) a sensor for direct normal irradiance (DNI) and a sensor on a single-axis tracker (SAT).

FIG. 10 is a plot showing a measured output for one system configured according to an embodiment of the invention. The plot illustrates the de-rating due to clouds and partial shade as a function of time. The clear-sky expectation for the system (Cᵢ) as well as for the ensemble of all systems (C_{g}) are shown for comparison.

FIGS. 11A, 11B illustrate motion vectors, without geometric correction and with geometric correction, respectively.

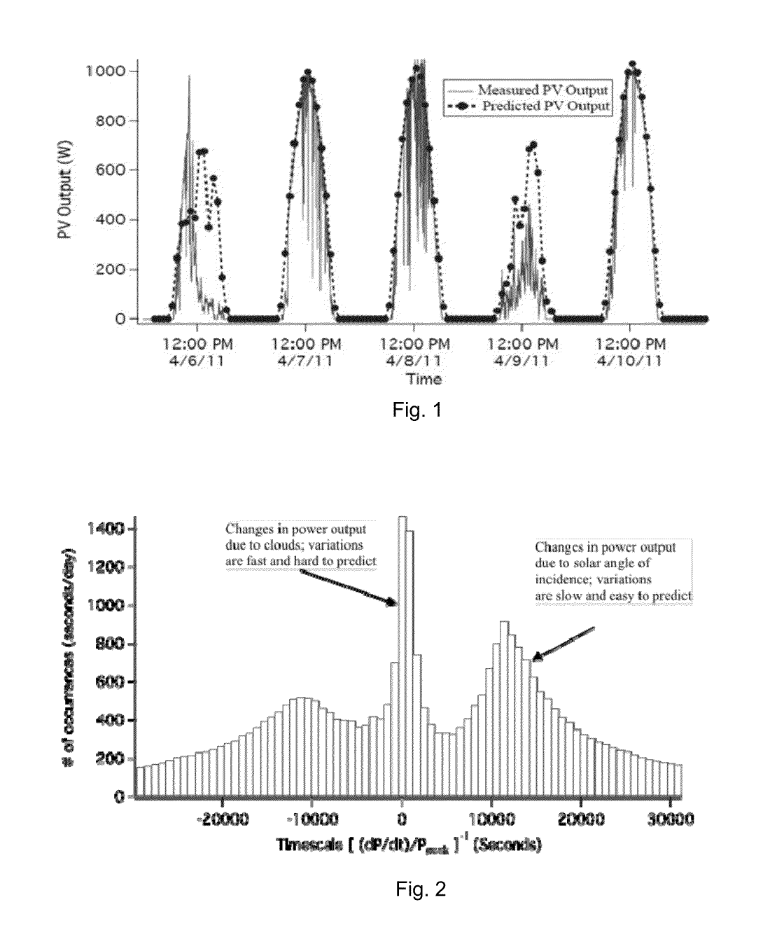

### DETAILED DESCRIPTION

The invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

### Example 1

In one embodiment of the invention, forecasting solar-power intermittency due to clouds is effectuated with the analysis of digital images acquired with a ground-based, suntracking camera disposed on an equatorial mount, an example of which is discussed in the portion of the U.S. patent application 61/857,144 titled “Forecasting Solar power Intermittency Using Ground-Based Cloud Imaging” and is presented in Appendix C thereof. According to this embodiment, a camera is placed at a PV installation such that it images the sky from the perspective of the PV installation. The camera is mounted on an equatorial mount such that one of its axes of rotation is parallel to the earth's access of rotation. A stepper motor rotates the camera along this axis at an angular velocity of approximately 360 degrees/24 hours such that the camera tracks the sun, the camera being positioned such that the sun is in the center of the camera's field of view. The equatorial mount also allows the camera to the rotated along an axis orthogonal to the sun's axis of motion to account for the seasonal movement of the sun above the horizon.

The camera images an approximately hemispherical field of view such that, when the sun it at its zenith, the camera images the entire sky. In one embodiment, the camera records a sequence of video frames (or movies) of, for example, 5 minutes of total duration at a frame rate of 1 frame per second. Successive frames are analyzed to detect clouds and compute their motion across the sky. A block-based motion estimation technique is used to track the motion of clouds in images of the sky. According to this technique, the current frame for which motion vectors are to be estimated (that is, a current all-sky field of view), is divided into blocks, for example, 63 blocks in a 7×9 grid. For each block in the grid that contains a cloud, the location in the previous frame that best matches the current block is determined. This comparison or matching step is performed by cross-correlating the current block under consideration with the blocks in the previous frame. The previous frame block for which the cross correlation value is the maximum is the best match.

Once the best match block has been identified, the motion vector of the cloud in the block under consideration is computed as the difference in coordinates between the block under consideration and the best match previous block. The magnitude of the motion vector is determined according to 1 frame per second frame rate of the camera.

Once velocity vectors for clouds have been determined in the data, they are adjusted for camera perspective. In particular, because of the perspective of the images, clouds far away on the horizon will have a smaller angular velocity than clouds overhead. The method according this embodiment of the invention corrects for this perspective distortion in order to obtain accurate forecasts. This correction is performed by converting the pixel coordinates of clouds to 3D position vectors in a real-world reference frame, which is done according to the method set forth in U.S. Provisional Application No. 61/857,144 (Appendix C). A perspective distortion correction takes into account that, because of the perspective of the images, clouds far away on the horizon have a smaller angular velocity than clouds overhead. Depending on the time of day, the optical axis of a camera points in a different direction. Hence, the perspective of the images changes over time and a correction for this perspective distortion is required in order to obtain accurate forecasts.

In order to compensate for the perspective distortion, pixel coordinates corresponding to clouds are converted to 3D position vectors in the real-world reference frame. To do this, a camera reference frame (right handed) is first defined such that V_{CX} and V_{CY} correspond to right and up in the image respectively and V_{CZ} points out of the image plane. For each pixel a unit length vector is defined in the camera reference frame that corresponds to the direction from the camera to the object being imaged at that pixel. For example, a cloud at coordinates (x,y) in an image would correspond to a vector \vec{V_{Cloud}^{C}}=(x,y,f)/|x,y,f|, where f is a constant determined by the imaging system (roughly equal to focal length/pixel size). The superscript indicates the reference frame, ‘C’ for the camera reference frame, ‘R’ for the real-world reference frame.

Then, a representation of \vec{V_{Cloud}^{C}} in the real-world reference frame (\vec{V_{Cloud}^{R}}) is determined. Specifically, a matrix T is found such that in the real-world frame,

$$\begin{matrix}T [ \begin{matrix}1 \\ 0 \\ 0\end{matrix} ] = \vec{{V}_{CX}^{R}} & ( 1 ) \\ T [ \begin{matrix}0 \\ 1 \\ 0\end{matrix} ] = \vec{{V}_{CY}^{R}} & ( 2 ) \\ T [ \begin{matrix}0 \\ 0 \\ 1\end{matrix} ] = \vec{{V}_{CZ}^{R}} & ( 3 )\end{matrix}$$

where \vec{V_{CX}^{R}}, \vec{V_{CY}^{R}} and \vec{V_{CZ}^{R}} are the coordinate vectors of the camera reference frame (V_{CX}, V_{CY}, and V_{CZ}) represented in real-world coordinates.

These three equations can be written as

$$T [ \begin{matrix}1 & 0 & 0 \\ 0 & 1 & 0 \\ 0 & 0 & 1\end{matrix} ] = T = [ \begin{matrix}{V}_{CX 1}^{R} & {V}_{CY 1}^{R} & {V}_{CZ 1}^{R} \\ {V}_{CX 2}^{R} & {V}_{CY 2}^{R} & {V}_{CZ 2}^{R} \\ {V}_{CX 3}^{R} & {V}_{CY 3}^{R} & {V}_{CZ 3}^{R}\end{matrix} ] .$$

What remains is to determine \vec{V_{CX}^{R}}, \vec{V_{CY}^{R}} and \vec{V_{CZ}^{R}}, which are the representations of V_{CX}, V_{CY}, and V_{CZ} in real-world coordinates.

In the real-world reference frame, the positive X direction (V_{RX}) points towards west, the positive Y direction (V_{RY}) points towards south and the positive Z direction (V_{RZ}) points vertically up with the respect to the ground.

\vec{V_{CZ}^{R}} is a known vector if we know the direction of the sun at any given instant of time. With the use of a solar position algorithm (such as, for example, that described in Solar Energy, vol. 76, no. 5, pp. 577-589, 2004), the zenith and azimuth angle of the Sun can be determined. These angles are determined, \vec{V_{CZ}^{R}} can be computed as

\vec{V_{CZ}^{R}}=[−sin φ sin θ,−sin θ cos φ, cos θ] (4)

where θ=zenith angle (angle from the vertical) in radians and φ=azimuth angle (eastward from the north) in radians. The camera is mounted on the tracker such that \vec{V_{CX}^{R}} is perpendicular to both \vec{V_{CZ}^{R}} and \vec{V_{CN}^{R}}; therefore, \vec{V_{CX}^{R}} is given by

$$\vec{{V}_{CX}^{R}} = \vec{{V}_{CN}^{R}} \times \frac{\vec{{V}_{CZ}^{R}}}{\vert \vec{{V}_{CN}^{R}} \times \vec{{V}_{CZ}^{R}} \vert} \qquad ( 5 )$$

where ‘x’ indicates cross product. \vec{V_{CY}^{R}} is perpendicular to both \vec{V_{CX}^{R}} and \vec{V_{CZ}^{R}} and is therefore given by

\vec{V_{CY}^{R}}=\vec{V_{CZ}^{R}}×\vec{V_{CX}^{R}} (6)

The cloud vector in the real-world reference frame is now given by

\vec{V_{Cloud}^{R}}=T\vec{V_{Cloud}^{C}} (7)

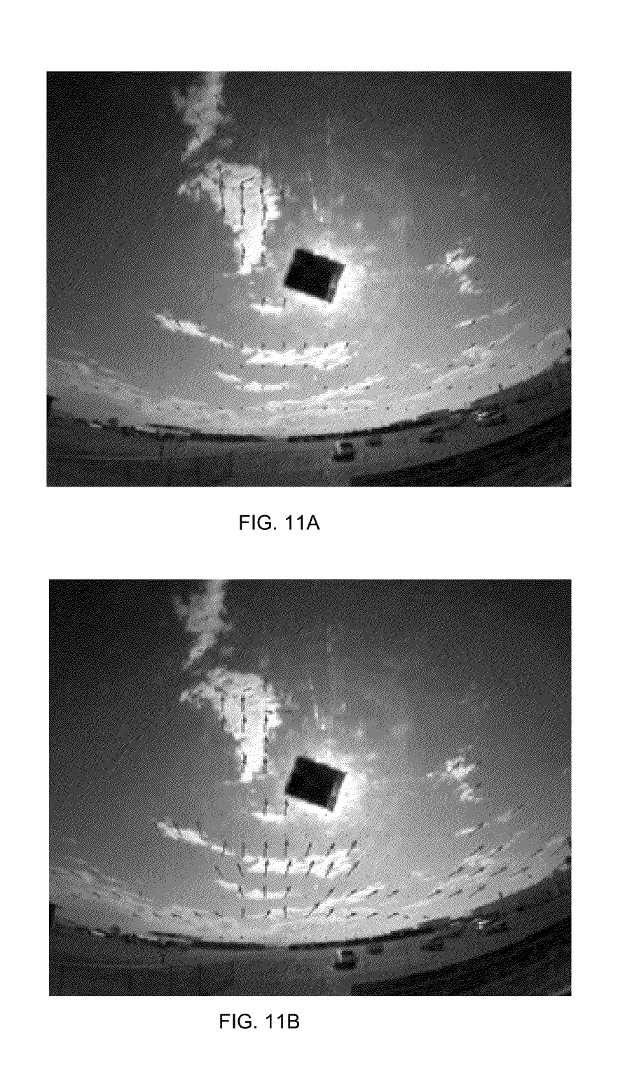

The transformation matrix T is a unitary matrix corresponding to a rotation. This means \vec{V_{Cloud}^{R}} still has unit length. We convert this unit length vector to a cloud position vector by multiplying by a constant such that the height of the cloud \vec{V_{Cloud}^{R}} is equal to, for example, 3000 meters (which is assumed to be the typical cloud height: a choice of the cloud height corresponding to physically intuitive values and does not affect predictions). One can now make estimates of cloud velocity and forecast cloud events. The results are shown in FIGS. 11A, 11B.

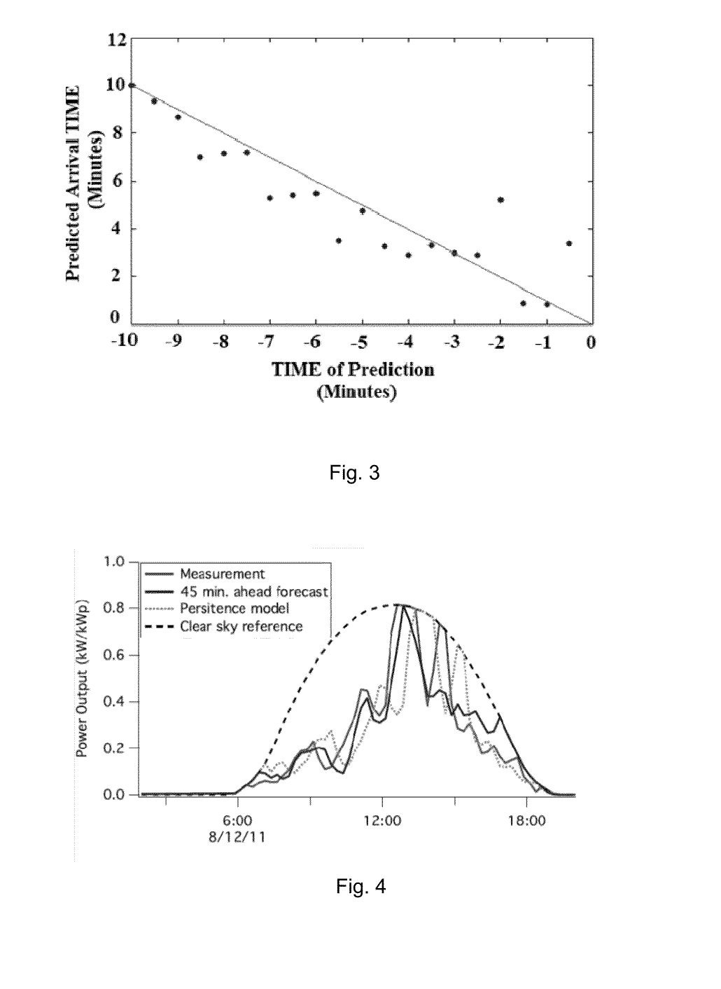

Once the perspective has been corrected for (i.e., once the system generates real-world velocity vectors for identified clouds), cloud arrival time is estimated for the identified clouds. An example of a description of a ten-minute-ahead forecast (a forecast with a time-horizon of <10 minutes) is shown schematically in FIG. 3. The dots represent the forecast generated according to the method of this embodiment, and the straight line represents the actual time before the cloud reaches the sun to block it from view. The RMS difference between the predicted and actual arrival, for a 10 minute time-horizon) is about 1.4 minutes.

As is set forth above, there are numerous problems stemming from relying on conventional numerical weather forecast models to predict time-varying irradiance at PV sites, particularly in locales such as Arizona, which are characterized by rapidly changing and highly localized weather events. According to another embodiment of the invention, a system and method is provided for using widely distributed PV installations themselves as irradiance detectors to increase the accuracy of weather models. This embodiment is set forth in additional detail in U.S. Provisional Application No. 61/857,144 (at Appendices B and F), which again, are set forth herein in their entirety. According to this embodiment, a distributed array of already installed PV systems is used as a solar irradiance detector array to detect weather phenomenon such as cloud shading.

The challenge associated with the use of a plurality of PV systems in this manner is to determine, when a particular PV installation experiences a drop in output power, whether such drop in output power is due to weather related shading of the Sun (e.g., from clouds, rain or dust), or whether it is due to other effects (such as, for example, a normal variation in irradiance that occurs throughout the day, shading that occurs due to nearby fixed objects, or electrical effects such as outages) that occur downstream of a particular PV panel. One has to remember that there are also power-output variations from a PV panel to a PV panel (that may relate not only to the type of a panel but also to the immediate environment of the panel's installation) that have to be accounted for. Ideally, the perfect performance of a PV panel at a particular installation during clear-sky conditions would be computed a-priori. Then any deviations from that such perfect condition would indicate the presence of weather-related shading. Numerous operational variables and uncertainties associated with and corresponding to a particular installation site, however, make such an approach less desirable.

Instead, embodiments of the invention are directed to measuring PV system performance over time and then taking cross-sections or slices of the measurement data to identify the difference(s) between derating effects (i.e., falloffs in irradiance) due to outages, shading (for example, from local fixed objects), and clouds. These derating effects are differentiated by their specific qualitative behavior: shading may occur at the same time of day for several days for a given system, outages may occur at different times of the day for a given installation, whereas the presence of clouds in the sky will be experienced at different times of day across multiple installations. The example follows.

### Example 2

In one specific implementation, the measurement system includes a ground-based sensor system including a grid of PV modules enabling the inference of the PV power output directly from the output of other PV modules and without independent estimates of cloud height, density, reflectivity, or spectral properties. The principal input to the forecasting algorithm includes measurements of PV power output from a multitude (in a specific example—eighty) residential systems distributed over a 50 km by 50 km area (in a specific example—on rooftops) and used to forecast PV power output. Measurement data are recorded at specified time intervals (for example, 15-minute intervals), and each measurement represents the AC power averaged over the previous time interval (in this case—15 minutes). Such a network has better spatial and temporal resolution than currently available operational forecasts based on GOES satellite (which has resolution of about 10 km and a data update rate of about an hour).

According to the present embodiment, a baseline clear-sky expectation Cᵢ(t) is determined for each PV module, or system i. The clear-sky expectation at a particular time on a given day is equal to the 80th percentile of the set of performance measurements (i.e., normalized power output) taken at the same time of day for 15 days:

Cᵢ(t)=Perc[{yᵢ(t−n*1 Day)},80] (8)

with nε{0 . . . 15}, where yᵢ(t) is the yield (kW/kWₚₑₐₖ) at time t for system i, and n is an integer in the range {0 . . . 15}.

The 80th percentile is used rather than the average to exclude outliers. The expected performance Cᵢ(t) still includes shading and outages that last multiple days, but eliminates the effect of clouds and short outages. Integrating the 80th percentile of power generated by a given installation over 15 days serves to exclude the transient effects caused by clouds and short term outages, but will still incorporate the effects of long term outages.

Similarly, a global clear-sky expectation C_{g}(t) for the clear sky performance of the entire assemblage of PV installations is computed as

C_{g}(t)=Perc[{Cᵢ(t)},80] (9)

Additionally, the real performance R_{g}(t) for the entire assemblage of PV installations is determined by taking the average performance values over time, such that cloud effects are included in this measurement:

R_{g}(t)=Perc[{yᵢ(t)},50] (10)

In order to exclude from the data the effects of long-term outages (e.g., instances where a string of PV modules fails for an extended period of time), a scaling factor is defined for each installation, where the scaling factor Sᵢ(d) for a particular installation i, is defined as that installation's yield (i.e., power over time normalized to peak power) to the real performance over time R_{g}(t):

$${S}_{i} ( d ) = Perc [ \frac{{y}_{i} ( t )}{{R}_{g} ( t )} , 80 ] \qquad ( 11 )$$

where, t ranges from 0:00 h to 23:45 h on the date denoted by d.

A day is flagged as including an outage if the scaling factor is more than 20% smaller than the average of the scaling factor, (Sᵢ (d)), over the time period for which data is available. In other words, a long-term outage is identified if the real performance of a particular system is less than 80% of the average performance of the ensemble of systems for a period lasting longer than a day. The outage de-rating for long (full-day) outages (Dₗₒᵢ(t)) is therefore given by

$${D}_{loi} ( t ) = \{ \begin{matrix}\frac{{S}_{i} ( d )}{〈 {S}_{i} ( d ) 〉} , & if \frac{{S}_{i} ( d )}{0.8} < 〈 {S}_{i} ( d ) 〉 〈 {R}_{g} 〉 > \frac{〈 {C}_{g} 〉}{2} \\ 0 , & otherwise\end{matrix} \qquad ( 12 )$$

Additionally, the method of this embodiment identifies outages having a smaller time scale in a similar manner, by comparing the yield of a particular installation with its own clear-sky expectation. (The clear sky expectation for a particular system averages out the effects of clouds and partial shading due to fixed objects.) Accordingly, if the yield of a particular system is below its own clear-sky expectation for some appreciable period of time, a short-term outage Dₗₒᵢ(t) is identified:

$${D}_{soi} ( t ) = \{ \begin{matrix}\frac{{y}_{i} ( t ) - {c}_{i} ( t )}{{c}_{i} ( t )} , & {y}_{i} ( t ) < 0.8 {C}_{i} ( t ) {R}_{g} ( t ) > 0.8 {C}_{g} ( t ) \\ 0 , & otherwise\end{matrix} \qquad ( 13 )$$

The total de-rating due to outages is then given by

$${D}_{oi} ( t ) = \{ \begin{matrix}{D}_{loi} ( t ) , & if {D}_{loi} ( t ) > 0 \\ {D}_{soi} ( t ) , & otherwise\end{matrix} \qquad ( 14 )$$

Additionally, the method detects partial shading—de-rating effects Dₛᵢ(t)—due to fixed objects (e.g., objects that cast shade over the panels of a particular installation at or near the same time every day). These effects are yielded by the difference between the clear-sky expectation for a particular system and the clear sky expectation for the ensemble.

$${D}_{si} ( t ) = \{ \begin{matrix}\frac{[ {C}_{g} ( t ) - {C}_{i} ( t ) ]}{{C}_{i} ( t )} , & \frac{[ {C}_{g} ( t ) - {C}_{i} ( t ) ]}{{C}_{g} ( t )} .0 .15 {D}_{oi} = 0 \\ 0 , & otherwise\end{matrix} \qquad ( 15 )$$

By applying the method of the present embodiment, the falloff in performance D_{ci}(t) due to clouds can then be computed as the difference between the actual yield of a particular system over time and the clear-sky expectation for that particular system in the absence of the performance falloffs due to the effects detected according to the methods set forth above:

$${D}_{ci} ( t ) = \{ \begin{matrix}{C}_{i} ( t ) - {y}_{i} , & if {D}_{loi} + {D}_{soi} = 0 \\ 0 , & otherwise\end{matrix} \qquad ( 16 )$$

FIG. 10 schematically illustrates the results of (8)-(16) for a single system by showing the plots for de-ratings due to partial shade given by (15) and de-ratings due to clouds given by (16) as a function of time. While the described procedure may not necessarily detect outages on very cloudy days or detect clouds during partial outages, partial shading of an irradiance detector is identified during cloudy periods and vise-versa.

Accordingly, a method has been described herein by which an ensemble of PV installations is used to detect shading effects due to clouds. It will be appreciated that, by employing such method, a map may be generated that includes dynamic cloud location and velocity data, which may be used to predict shading of PV installations at other locations, and/or, can be used to augment other weather prediction data for any other purpose. In particular, since the method set forth above is capable of detecting clouds, by combining that data with data regarding the velocity of wind acting on the clouds, dynamic predictions for cloud shading may be obtained.

### Example 3

In one embodiment, a cloud shading algorithm is based on determining the “clear-sky expectation” for the output of each system (described above, and in the material incorporated by reference into this application), which is later corrected for outages, system orientation, and partial shade due to permanent obstacles (that do not include clouds). The “clearness index” K is then defined as a time-dependent ratio of the irradiance at the plane of the detector array, denoted as POA(t), and the modeled irradiance at the same plane in the absence of clouds, denoted as POA_{clear}(t):

$$K ( x , y , t ) = \frac{POA ( x , y , t )}{{POA}_{clear} ( x , y , t )} \qquad ( 17 )$$

Since the output of any particular PV system normalized by peak power is approximately proportional to POA irradiance, then

$${K}_{i} = \frac{{p}_{i} ( t )}{{p}_{i , clear} ( t )} \qquad ( 18 )$$

where pᵢ(t) is the normalized power output for the ith PV system and p_{i,clear}(t) is the power that would be generated under the clear sky.

The value of the clearness index takes into account the opacity of the atmosphere and is equal to “1” when no clouds are present, day or night. The deviation(s) of the value of K from such “clear sky” expectation is attributed to the presence of clouds at a given location. Values of K at locations between the points where the individual detectors (in this case—PV modules) are located are determined by the interpolation. The forecast of the clearness index K at later time (t+dt) and at a predetermined location (x, y) is then made according to Eq. (3) of Appendix F of U.S. 61/857,144 that reads

K(x,y,t+dt)=K(x−v_{X}dt,y−v_{Y}dt,t) (19)

where vₓ and v_{y} are the x- and y-components of the cloud velocity. Values of K at locations between the points where PV systems are located are determined by interpolation

In systems operating according to the present embodiment, irradiance data are obtained using existing PV infrastructure (e.g., existing PV installations distributed over some appreciably wide area—in one example 80 residential rooftop PV systems distributed over a 50 km×50 km area) equipped with data communications hardware in communication with a central data collection an analysis server executing computer readable instructions capable of carrying out the data analysis functions described above.

In order to translate instantaneous detection of clouds over given PV systems into data useful for the prediction of future cloud shading, wind velocity in the vicinity and altitude of the detected cloud is determined. Any method that yields wind velocity data for the vicinity and altitude of the detected clouds is acceptable. For example, in some embodiments, numerical weather modeling data (e.g., wind velocity from the day and locale's WRF model) is used.

Alternatively or additionally, cloud velocity is inferred from the network of PV systems by finding the velocity (v_{X}, v_{Y}) that is the best fit solution to the equation:

Ki(t)=K(xi−v_{X}dt,yi−v_{Y}dt,t−dt) (20)

for all PV system locations (xi, yi). Alternatively or additionally, a constant wind velocity throughout the day is assumed which is numerically optimized (retrospectively, on an ongoing basis) to minimize the RMS error between predicted cloud shading effects and measured cloud shading effects, again, which are detected on an ongoing basis.

For short time horizons (i.e., less than an hour), the method according to the present embodiment performs substantially better than WRF models using the WRF cloud persistence model. This is illustrated in FIG. 4, which shows an example of PV power measurements graphed against a 45-minute forecast of PV performance using the sensor system of the invention in comparison with the clear sky reference and the persistence model (which assumes that the clearness index K at a future time is the same as the clearness index at the initial moment of time, i.e., that assumes that the cloud velocity is substantially zero). It is worth noting that the RMS error of the WRF persistence model is about 0.12, while the RMS error of the embodiment of the invention is only 0.07. The empirical data clearly demonstrates an improvement over forecasts made based on satellite images (which are not available for time horizons less than about 1 hour). The prediction data of FIG. 4 was generated according to the second method described above for estimating cloud velocity, i.e., inferring cloud velocity from the overall PV measurement data.

### Example 4

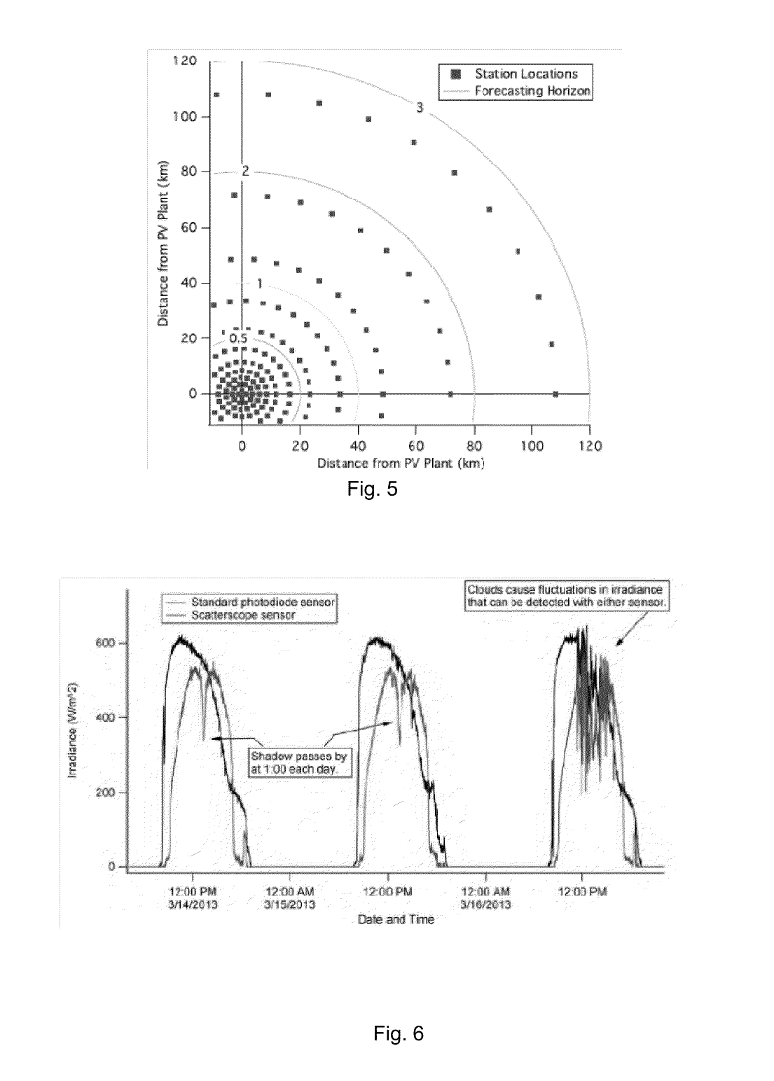

Another embodiment of the invention, which is discussed fully in Appendix F to U.S. Provisional Patent Application No. 61/857,144, provides a model for spatio-temporal correlation of the clouds to describe errors of forecasting the clearness index (based on the determination of at least covariance and/or correlation between two measurement of the index K at different times and locations) and enables the determination of optimal spacing between the immediately adjacent irradiance sensors of the measurement system for a given time-horizon of the forecast and depending on the cloud velocity. The example of such optimal spacing for a cloud velocity of 40 km/h is shown schematically in FIG. 5.

### Example 5

Thus far, methods for detecting clouds and predicting their movements have been discussed, which fall into two broad categories: first, direct imaging of clouds from a ground-based camera system located in the vicinity of a PV installation, and second, using PV modules themselves as irradiance detectors by analyzing data regarding the amount of AC power generated by the PV systems' inverters. Another embodiment includes a remote irradiance sensor structured to measure the scattered light (and referred to herein as a “scatterscope”). This detector is described in U.S. Provisional Patent Application No. 61/857,144, Appendix D, which again is incorporated herein in its entirety. The scatterscope irradiance detector is used to monitor irradiance on surfaces, such as distant rooftops, building walls, mountains, the ground, or other objects which scatter incident solar light. Such a device is useful, for example, in areas where direct irradiance data is not available from a PV installation, but the gathering of irradiance data is necessary for useful cloud formation or motion prediction. For example, sensor(s) in one or more of the PV locations corresponding to FIG. 5 may be replaced with a remote irradiance sensor.

In one embodiment, an irradiance detector according to the present embodiment includes a photodetector used in conjunction with field of view limiting optics, such as baffles, imaging lenses, and/or a cylindrical tube. In one embodiment, the irradiance detector includes a photodiode located at the focal point of a lens and housed in a cylindrical housing having disposed therein or on a dark, light absorbing cladding material (e.g., black felt, oxide or the like), with the components arranged to minimize stray light reaching the photodetector from sources other than the remote target object located within the instrument's field of few. It will be appreciated that the arrangement thus described is a scattered light detector that images parts of a scene onto a detector. However, the angular characteristics of light scattered from the target may be included in the clear sky profiles generated to use data from this type of irradiance detector in a forecasting algorithm. One reason this works is that the target's scattered radiance at any time will in general be proportional to the irradiance it receives.

The inventors discovered that the use of a remote irradiance detector (such as the scatter scope described above) may be more convenient to deploy for detecting shading of the ground by clouds as compared to a conventional, direct irradiance, detectors. Evidence that the he remote irradiance sensor is sufficiently effective shown in FIG. 6, which includes plots of irradiance obtained with a typical photodiode detector (conventionally used as an irradiance detector) and with a scatterscope according to the present embodiment. As can be seen, the scatterscope is sensitive to the fluctuations of irradiance due to the presence of clouds. At the same time, and in contradistinction to the conventionally used detector, the scatterscope enables an indoor detection unit monitoring the outdoor conditions in scattered—not direct—light. It is also possible to detect the solar irradiance at several different locations remotely with several scatterscopes all located in one room or station, but viewing in slightly different angles, hence observing different targets. Thus the primary benefits of the scattered light detector are the ability to measure irradiance on remote sites, and the ability to do so from locations that are not themselves in direct sunlight.

While the invention is described in reference to the above-described examples of embodiments, it will be understood by those of ordinary skill in the art that modifications to, and variations of, the illustrated embodiments may be made without departing from the inventive concepts disclosed herein. For example, the determination of spatial map of irradiance distribution across the pre-defined area or geographical region can be effectuate with PV-based DC detectors (such as already described PV-based systems on roof-tops), electrical inverters, multiple single point detectors, or even traffic cameras that are pointed in a direction of the ground. The use of traffic cameras for this purpose would effectuate the determination of contrast of shadows produced on the ground by the moving clouds.

### Example 6

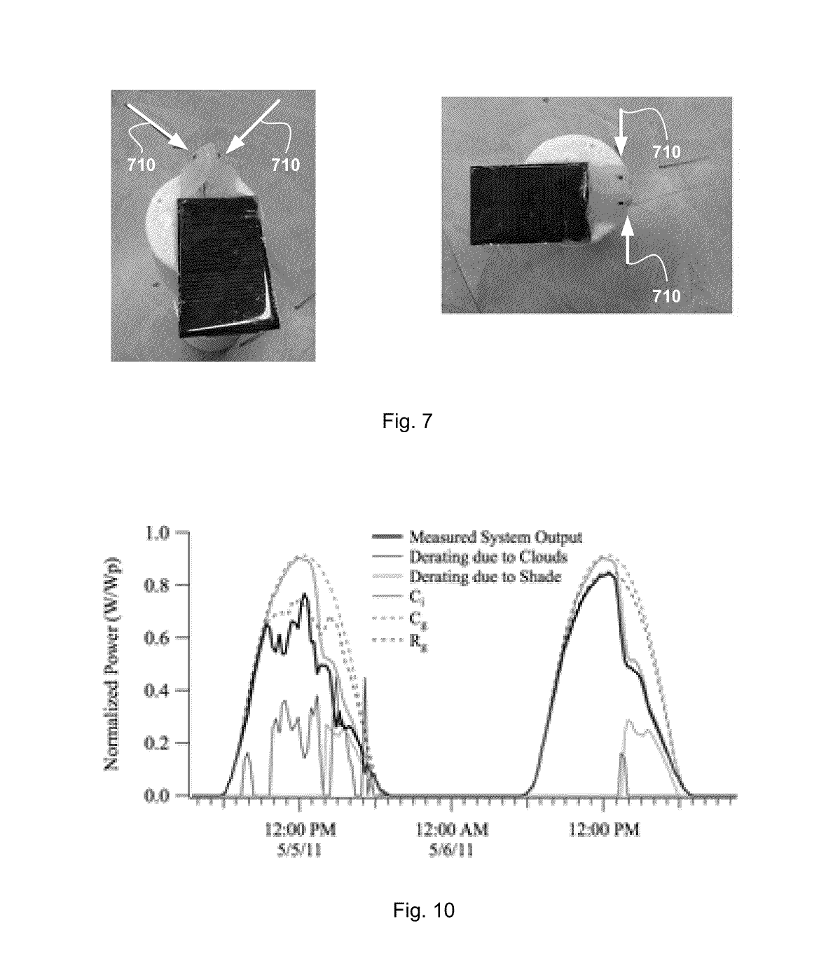

In another example, in one embodiment a combination of two or more hemispherical photodetectors facing at a variety of orientations. For example, ensembles with a detector facing at +45 degrees altitude and oriented towards the East and a similar detector pointed at 45 degrees altitude and oriented towards the West, and a similar detector oriented towards the zenith have been tested As compared with a single “all-sky” irradiance sensor pointed from the surface towards the sky, the operation of such detector system is characterized by increased signal-to-noise (SNR) ratio, while differences in performance attributed to seasonal differences remain operationally insignificant. FIG. 7 illustrates a specific embodiment, in which at least two irradiance sensors, indicated with arrows 710, are co-located on one instrument. Perspective view (left portion of FIG. 7) and top view (right portion of FIG. 7) are shown. One sensor faces East, the other faces West, and both are oriented at approximately 45-degree altitude, in order to have at least one detector facing towards the Sun at all times of day.

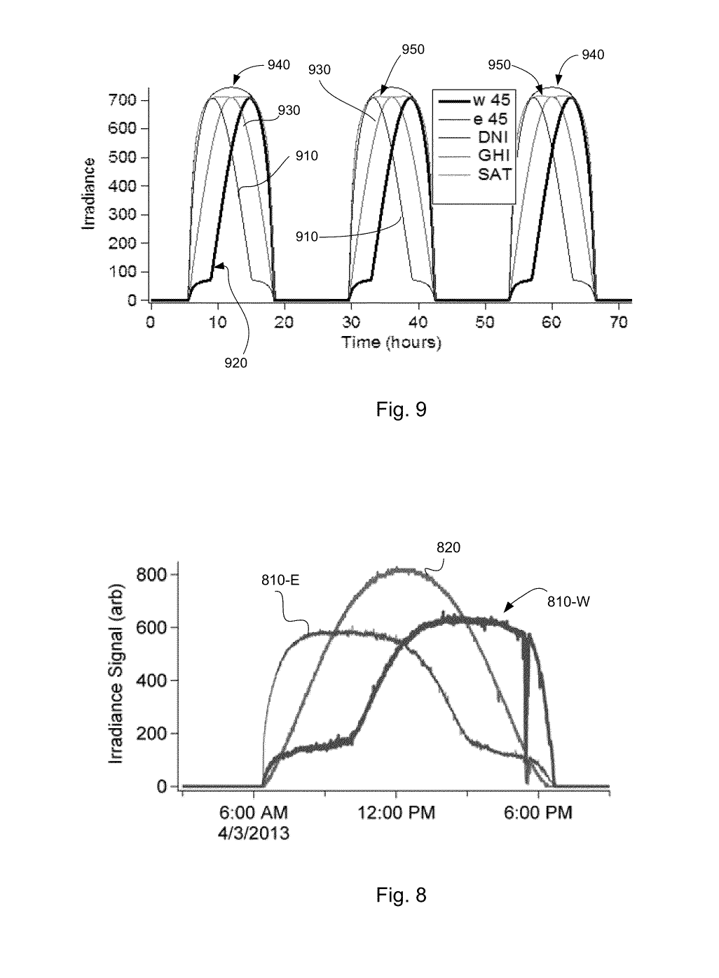

FIG. 8 shows a plot of time-dependent irradiance representing data from irradiance sensors of FIG. 7 facing in different directions. During several hours between sunrise and noon, the east-facing sensor exhibits higher SNR (as shown by the curve 810-E), and more shallow a slope as compared to a situation when a global horizontally positioned (looking up into the sky) irradiance sensor is used (curve 820). In the afternoon, the west-facing detector of the embodiment of FIG. 7 (curve 810-W) exhibits similar operational advantages. The information contained in plots of FIG. 9 sheds additional light on advantages to be derived from employing, in an embodiment of the invention, a combination of multiple photodetectors the lines of sight of which are inclined with respect to the horizon. Here, compared are the plots representing the results of the simulation of the irradiance signal acquired from the photo sensors facing east (e45, curve 910) or west (w45, curve 920) at 45 degree altitude, and also for a horizontal sensor that monitors global horizontal irradiance (GHI, curve 930), a sensor for direct normal irradiance (DNI, curve 940) and a sensor on a single-axis tracker (SAT, curve 950).

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A method for forecasting power variations from a photovoltaic (PV) system due to transient weather phenomena, the method including:
with a data-processing system including a central server in communication with a spatial network of irradiance sensors, acquiring time-dependent data from the spatial network of irradiance sensors;
determining a clear sky expectation function including effects of shading on the irradiance sensors to form a determined clear sky expectation function;
correcting the determined clear sky expectation function for at least one of a presence of clouds, power outage, communications outage, partial shade, and orientation of an irradiance sensor to derive derated clear sky expectation function;
determining a position-dependent clearness index representing power output from irradiance sensors; and
estimating said clearness index at a second time based at least on a component of a velocity of clouds at a first time, the second time being greater than the first time.

2. A method according to claim 1, further comprising determining a time-dependent clear sky expectation function for an irradiance sensor based on a chosen percentile of data acquired from the spatial network of irradiance sensors acquired during a chosen time-period.

3. A method according to claim 2, wherein the chosen percentile of data is the 80th percentile of data.

4. A method according to claim 1, wherein the acquiring data includes acquiring data, at each of predetermined time intervals, said data representing an average AC power output from the PV system over a time interval preceding each of predetermined time intervals.

5. A method according to claim 1, wherein the estimating includes estimating said clearness index at a second time based at least on a component of a velocity of clouds that has been determined based on at least one of a reference wind velocity data.

6. A method according to claim 1, wherein said acquiring includes acquiring data from first and second irradiance sensors disposed with their respectively corresponding optical axes inclined with respect to the horizon at first and second inclination angles, the first sensor facing towards east and the second sensor facing towards west.

7. A method according to claim 1, wherein the acquiring includes the acquiring data with an optical system located indoors and structured to collect sunlight scattered outdoors.

8. A method according to claim 1, wherein the acquiring data includes acquiring data from photovoltaic power generating installations.

9. A method according to claim 1, wherein the correcting includes excluding effects of long-term outages by comparing a yield of a particular irradiance sensor with an average yield of the spatial network of irradiance sensors.

10. A method according to claim 1, wherein the correcting comprises excluding the effects of partial shading by comparing a clear sky expectation function of a particular irradiance sensor with a clear sky expectation function of the spatial network of irradiance sensors.

11. A method according to claim 1, wherein the estimating said clearness index includes estimating the clearness index based at least on a component of a velocity of clouds, which component is determined by at least one of using numerical weather modeling, overhead satellite imagery data, sky imagery data from a ground based camera, and analysis of time-varying data collected from the spatial network of irradiance sensors.

12. A method according to claim 1, wherein the acquiring time-dependent data includes recording data at controlled time intervals.

13. A method according to claim 1, wherein the determining a position-dependent clearness index includes determining a position-dependent clearness index representing a spatial map of ratios of normalized power outputs from irradiance sensors under conditions corresponding to the derated clear sky expectation function to a normalized power output of a chosen irradiance sensor under a clear sky.

14. A method for producing a weather forecast with a use of an optical detector unit, comprising:
with a data processing unit, determining a figure-of-merit (FOM) representing a time-dependence of a change in a power output from the optical detector unit based on at least first data representing irradiance of sunlight received by the optical detector unit, second data representing shading of the optical detector unit, third data containing information about a wind velocity, and fourth data describing orientation of the optical detector unit;
running a weather research and forecasting (WRF) model that includes the FOM as an initial condition to obtain a weather model output corrected for presence of clouds.

15. A method according to claim 14, wherein the WRF model includes a horizontal grid spacing of less than 2 km.

16. A method according to claim 14, wherein the corrected weather model output represents forecast data with a forecast horizon of about 72 hours.

17. A method for predicting cloud shading, comprising:
recording images of a scene within a field-of-view (FOV) of an imaging system positioned near ground to produce a time-sequential set of image frames, the FOV subtending the Sun,
identifying a cloud in an image frame of interest to determine a first position thereof in said image frame;
comparing the first position with a second position of the same cloud in a previous image frame; and
computing a velocity vector on a basis of a difference between the first and second positions.

18. A method according to claim 17, wherein the recording includes recording images with a Sun-tracking camera on an equatorial mount.

19. A method according to claim 17, further comprising applying perspective correction to the computed velocity vector to form a perspective-corrected computed velocity vector.

20. A method according to claim 19, further comprising producing an output containing a prediction of time when an identified cloud will pass in front of the Sun based on the perspective-corrected computed velocity vector.
